(19) United States
(12) Patent Application Publication
(10) Pub. No.: US 2009/0064874 A1
(43) Pub. Date: Mar. 12, 2009

(54) Method and food holding cabinet with humidity generation

(75) Inventor: Ming Sun Chew, Cactus Green (SG)

Correspondence Address: Paul D. Greeley;Ohlandt, Greeley, Ruggiero & Perle, L.L.P., 10th Floor, One Landmark Square, Stamford, CT, 06901-2682, US

(73) Assignee: FABRISTEEL PRIVATE LIMITED

(21) Appl. No.: 12/229,420

(22) Filed: Aug. 22, 2008

Related U.S. Application Data
(60) Provisional application No. 60/966,104, filed on Aug. 24, 2007.

(51) Int. Cl. A47J 43/00; B05B 15/00; B05B 17/04

(52) U.S. Cl. 99/473; 239/200; 239/4

(57) ABSTRACT

A food holding cabinet that has a plurality of food warming cavities. An ultrasonic misting device is disposed to provide mist to humidify at least one of the food warming cavities. The misting device comprises a well that holds water and a plurality of ultrasonic transducers. A controller actuates the ultrasonic transducers to produce a mist that is conveyed to the food warming cavity by a mist duct and a mist dispenser that distributes the mist evenly in the food warming cavity.

### RELATED APPLICATION

This application claims the benefit of U.S. Provisional Application Ser. No. 60/966,104 filed on Aug. 24, 2007, the entire contents of which are incorporated herein by reference.

### BACKGROUND

1. Field

The present disclosure relates to a method and food holding cabinet for providing humidity within the cabinet to keep food products moist.

2. Discussion of the Background Art

Traditionally, water has been heated up to create steam, which in turns creates humidity in a chamber. For example, FIG. 1 shows a water heating tray that produces steam to provide humidity in a chamber of a food holding cabinet or of an oven. The steam comprises rather large droplets of water that result in uneven absorption by the food products. The steam generator component consumes a relatively large amount of electrical energy and requires considerable time to produce steam.

Thus, there is a need to provide a method and a food holding cabinet that overcomes the disadvantages of the traditional food holding cabinets that use steam to provide humidity.

The advantages of the present disclosure as compared to the traditional method are as follows:
1) The present disclosure comprises a device that creates a mist made up of very minute droplets of water and requires lesser electrical energy as compared to larger droplets of water and higher energy of the conventional method of creating steam by heating water. As the droplets are significantly smaller, the mist can be absorbed more evenly and faster by the food products. The even absorption of moisture into the product improves product holding and maintains food quality as compared to using steam.
2) The misting device preferably uses ultrasonic technology that consumes significantly less electrical energy as compared to creating steam through heating up water.
3) The creation of mist through ultrasonic technology is considerable quicker than creating steam through heating up water.

The present disclosure also provides many additional advantages, which shall become apparent as described below.

### SUMMARY

A method and system for generating fine water mist by means of ultrasonic transducers that are fitted at the base of a water tank, which is delivered to a food holding cabinet via a plurality of ducts. The device is housed within the food holding equipment to provide humidity thereto.

A food holding cabinet of the disclosure comprises a plurality of walls that define a food holding chamber and an ultrasonic misting device disposed to inject a fine mist into the food holding chamber to provide a humid environment.

In one embodiment of the food holding cabinet, the ultrasonic misting device comprises a well that holds a liquid and a plurality of ultrasonic transducers that agitate the liquid to produce the fine mist.

In another embodiment of the food holding cabinet, the ultrasonic transducers are disposed in a bottom of the well.

In another embodiment of the food holding cabinet, the ultrasonic misting device further comprises first and second float switches disposed in the well and a controller that responds to the operation of the first and second float switches to operate the ultrasonic transducers to agitate or not agitate the liquid.

In another embodiment of the food holding cabinet, a mist dispenser distributes the fine mist evenly in the food holding chamber.

In another embodiment of the food holding cabinet, a duct conveys the fine mist from the well to the mist dispenser.

In another embodiment of the food holding cabinet, a plurality of tiers is provided and the fine mist is injected into a lower one of the tiers.

A method of the disclosure provides humidity to a food holding chamber by operating one or more ultrasonic transducers to agitate a liquid to produce a fine mist and injecting the fine mist into the food holding chamber.

In one embodiment of the method, a well is provided to hold the liquid.

In another embodiment of the method, the operating step responds to a level of the liquid in the well to agitate or not agitate the liquid.

In another embodiment of the method, the fine mist is distributed evenly in the food holding chamber.

In another embodiment of the method, the food holding chamber comprises a plurality of tiers. The fine mist is injected into a lower one of the tiers.

Further objects, features and advantages of the present disclosure will be understood by reference to the following drawings and detailed description in which like reference numerals denote like elements of structure.

### BRIEF DESCRIPTION OF THE DRAWINGS

FIG. 1 is a top front left-side perspective view of a conventional steam-based humidity creating system;

FIG. 2 is a top front left-side perspective view of a first embodiment of the food holding cabinet with ultrasonic misting device according to the present disclosure;

FIG. 3 is a top rear left-side perspective view of the ultrasonic tank of the ultrasonic misting device of the food holding cabinet of FIG. 2;

FIG. 4 is a top front right-side perspective view of the ultrasonic tank of ultra sonic misting device of the food holding cabinet of FIG. 3;

FIG. 5 is a bottom front right-side perspective of the ultrasonic tank of FIG. 4;

FIG. 6 is top front side perspective view of a second embodiment of the food holding device of the present disclosure;

FIG. 7 is a top front perspective view of the food holding cabinet of FIG. 6 with top and food racks removed;

FIG. 8 is a top rear perspective view of the view of FIG. 7;

FIG. 9 is a perspective top perspective view of the ultrasonic misting device of the holding cabinet of FIG. 6.

FIG. 10 is a top perspective view of the ultrasonic misting device of FIG. 9 with top cover removed; and

FIG. 11 is a bottom perspective view of the ultrasonic misting device of FIG. 9.

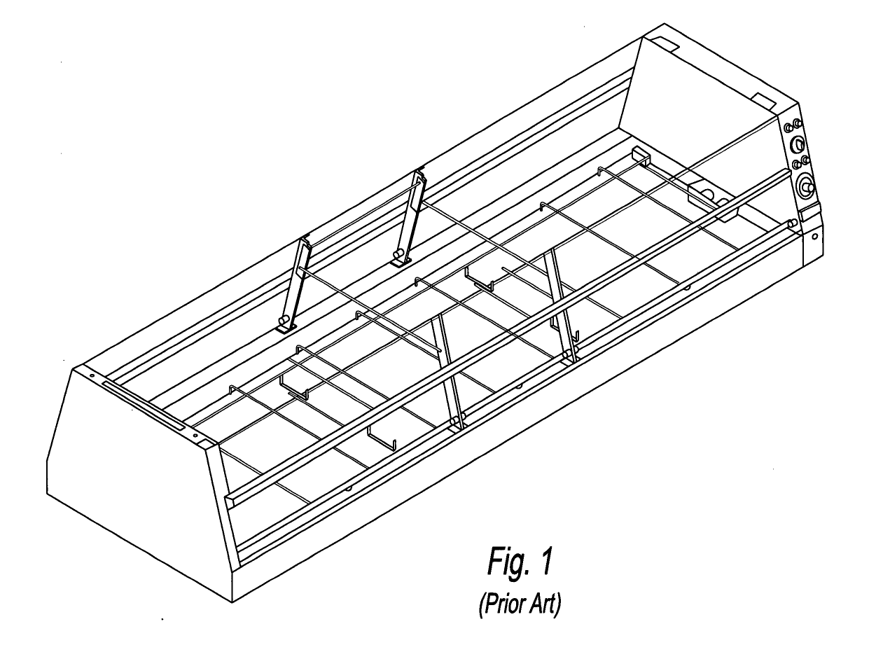

### DETAILED DESCRIPTION OF THE PREFERRED EMBODIMENT

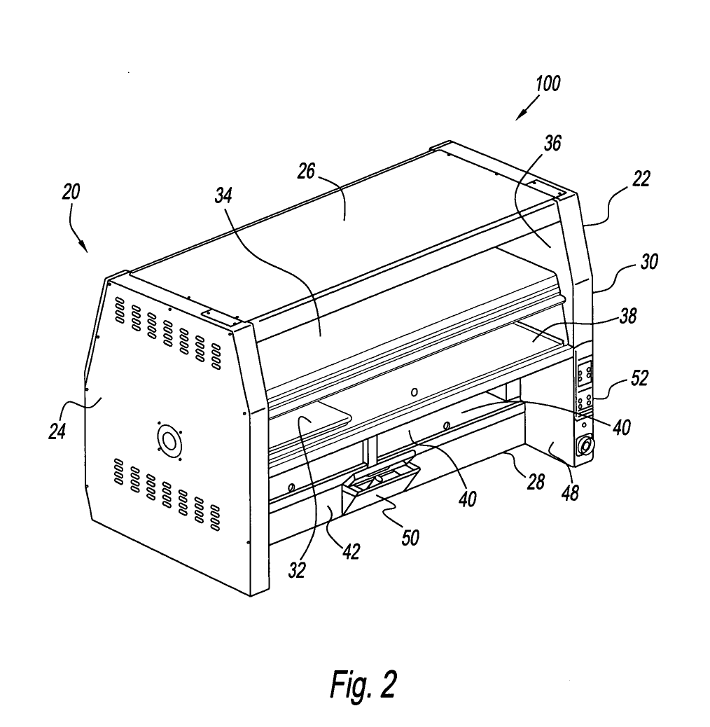

Referring to FIG. 2, a first embodiment of a food holding device 20 according to the present disclosure comprises side walls 22 and 24, a top wall 26 and a bottom wall 28 that define a food holding chamber 30 for keeping previously cooked food products warm. A plurality of food racks 32 and 34 divide food holding chamber into a top tier cavity 36, a middle tier cavity 38 and a bottom tier cavity 40. Separate transparent, see-through doors (not shown) cover middle tier cavity 38 and bottom tier cavity 40 so that customers may view food products being kept warm.

Bottom tier cavity 40 is bounded at its lower extremity by a food product surface 42 formed in bottom wall 28. An ultrasonic misting device 50 is disposed in bottom wall 28. Ultrasonic misting device 50 is operable under control of a controller 48 to inject a fine mist in bottom tier cavity 40 to provide a humid environment. A control panel 52 is located in side wall 22 to provide user entered settings to controller 48. Food products that need to be kept moist are suitably kept moist in bottom tier cavity 40. Food products that do not require as much moisture are kept in middle tier cavity 38 and top tier cavity 36. For example, top tier cavity 36 can hold pre-packed food products or crispy food products and middle tier cavity 38 can hold crispy food products.

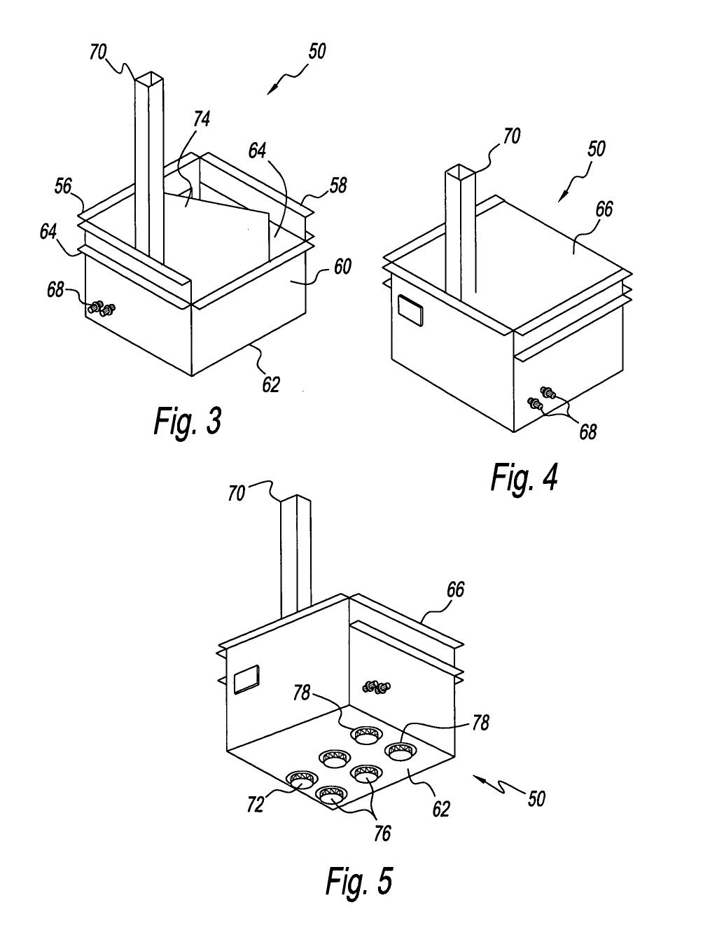

Referring to FIGS. 3-5, ultrasonic device 50 comprises a bottom wall 62 and at least one wall, and preferably four walls 54, 56, 58 and 60 that together with bottom wall 62 form a tank or well 64. A top cover 66 (removed in FIG. 3) covers well 64. A pair of float switches 68 are disposed in well 64 and extend through side wall 54 for connection via electrical wires (not shown) to controller 48. A misting duct 70 is disposed in well 64 and extends through top cover 66. A drain port 72 is disposed in fluid communication with well 64. A liquid inlet fitting (not shown) extends through bottom wall 62 into well 64. The liquid inlet fitting is connected via tubing and a valve (not shown) to a source (not shown) of liquid, (e.g., water). A plurality of ultrasonic transducers 76 are affixed to bottom wall 62 and arranged in a spacing to provide adequate agitation to water in well 64 to produce a fine mist. Ultrasonic transducers 76 comprise terminals 78 for connection via electrical wiring to controller 48.

Controller 48 controls the filling of well 64 based on float switches 68. When the water level dips below the lower float switch 68, controller 48 responds by operating the liquid valve to supply water via the liquid fitting to well 64. When the water level reaches the upper float switch 68, controller 48 responds by operating the liquid valve to stop supplying water to well 64. Optionally, well 64 can be filled manually when top cover 66 is removed.

The fine mist is delivered to bottom tier cavity 40 via misting duct 70. To more evenly distribute the mist in bottom tier cavity 40, misting duct 70 is connected with a mist dispenser (or manifold) 80 as shown in FIG. 2. Mist dispenser 80 extends laterally across bottom tier cavity 40 to more evenly distribute the fine mist over food product surface 42.

In FIG. 5, the transducers 70 are shown arranged in two rows. It will be apparent to those skilled in the art that other arrangements can be used. Ultrasonic transducers 70 are operable in the wavelength range of 1650 KHz to 1750 KHz.

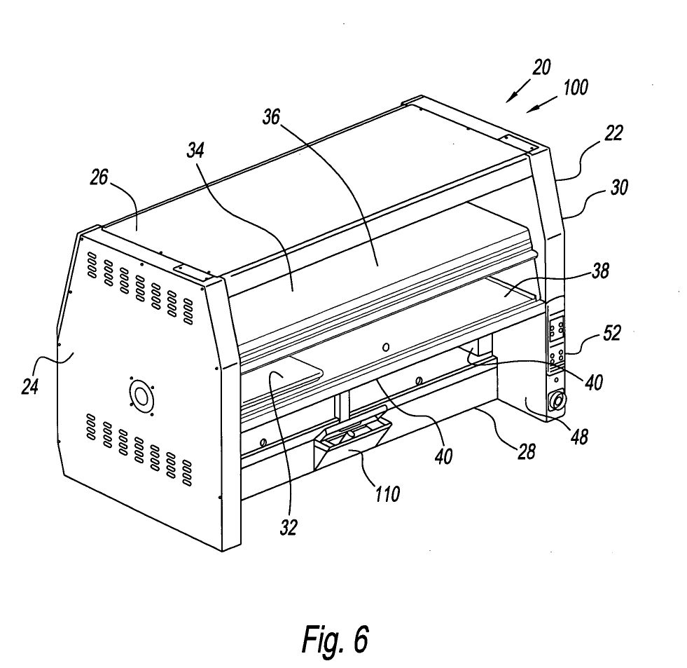

Referring to FIGS. 6-8, a second embodiment of the food holding cabinet of the present disclosure is denoted by reference numeral 100. Food holding cabinet 100 has some components that are identical to and bear the same reference numerals as components of food holding cabinet 20 of FIG. 2.

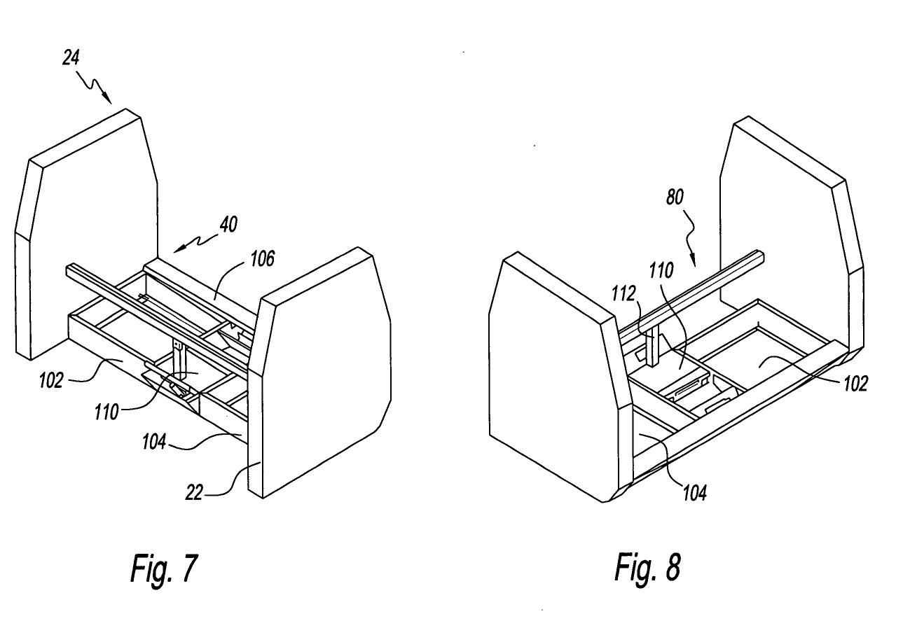

Food holding cabinet 100 differs from food holding cabinet 20 in that the ultrasonic misting device and the interior of the bottom tier cavity are different. Referring to FIGS. 7 and 8, food holding cabinet 100 comprises an ultrasonic misting device 110 disposed on bottom wall 28. A food tray 102 and a food tray 104 are also disposed on bottom wall 28 on opposite sides of ultrasonic misting device 110. Food trays 102 and 104 are preferably removable to facilitate ease of cleaning and maintenance. An air duct 106 (shown only in FIG. 7) extends between side walls 22 and 24 adjacent the front.

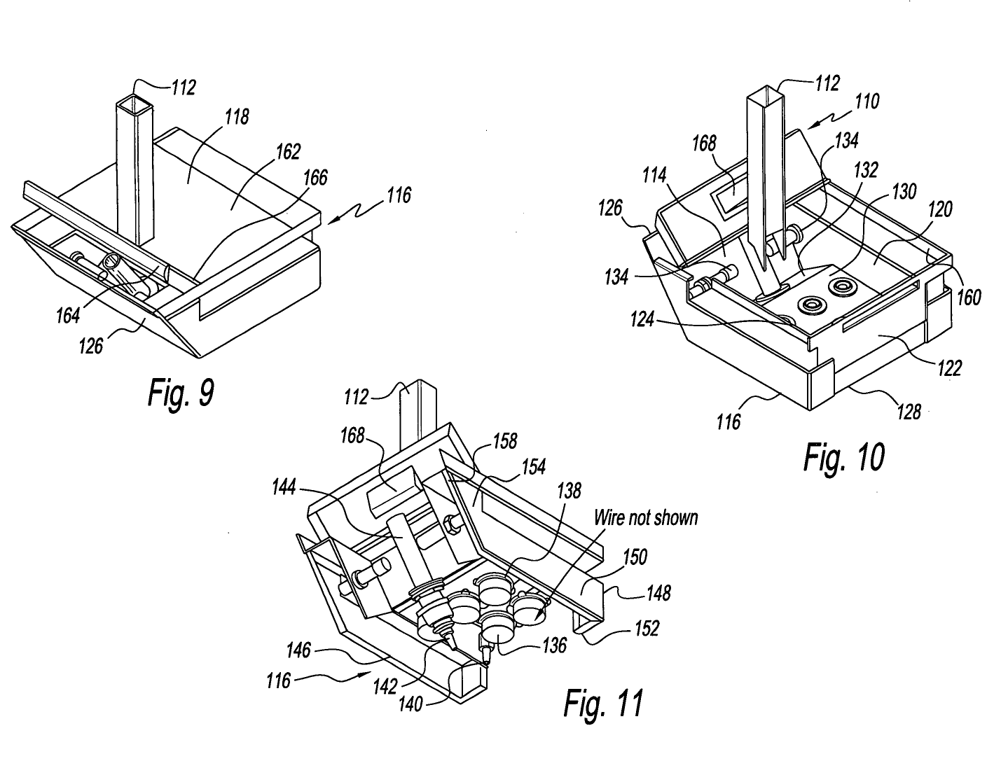

Referring to FIGS. 9-11, ultrasonic misting device 110 comprises a well 114 disposed in a frame 116 and a cover 118 that covers well 114. Frame 116 comprises side walls 120, 122, 124 and 126 and a bottom wall 128 that collectively form well 114. Bottom wall 128 has a bottom portion 130 and a bottom portion 132. Bottom portion 130 is horizontal and mates with bottom portion 132 and side walls 120, 122 and 124. Bottom portion 132 ramps downwardly and mates with bottom portion 130 and side walls 120, 124 and 126. Side wall 126 has a slope that ramps upwardly from the intersection with bottom wall portion 132. Side wall 126 and bottom portion 132 are removed in FIG. 11. A misting duct 112 has one end disposed in well 114 and extends vertically through cover 118 to mate with mist dispenser 80 (FIG. 8) to distribute mist evenly throughout the bottom tier cavity 40 to food trays 102 and 104.

Referring to FIGS. 10 and 11, a pair of float switches 134 are disposed in well 114 and extend through side walls 120 and 124 for connection via electrical wires (not shown) to controller 48. One of the float switches 68 (upper float switch) is higher than the other (lower float switch). A drain pipe 144 is disposed in well 114 and extends through bottom wall portion 132 for connection to a drain fitting 142 that is connected to tubing (not shown) for disposal of liquid accumulated due to condensation of steam in lower tier cavity 40. A liquid inlet fitting 140 extends through bottom wall portion 130 to provide liquid to well 114. Liquid inlet fitting is connected via tubing and a valve (not shown) to a source (not shown) of liquid, (e.g., water). A plurality of ultrasonic transducers 136 is affixed to bottom wall portion 130 and arranged in a spacing to provide adequate agitation to water in well 114 to produce a fine mist. Ultrasonic transducers 136 comprise terminals 138 for connection via electrical wiring to controller 48.

Frame 116 further comprises a cover support 160 and side supports 146 and 148 that support well 114. Side supports 146 and 148 are substantially identical so only side support 148 will be described in detail. Side support 148 is L-shaped and comprises a long leg portion 150 and a short leg portion 152 that extends toward side wall 122. Side support 148 is shaped along a bottom edge to rest on bottom wall 128 of food holding cabinet 100. Side support 148 at its end opposite shot leg portion 152 has an upwardly sloped edge 158 that mates with side wall 126. Also at its opposite end, side support 148 has an upper portion 154 that serves as a support for cover 160. Side support 148 further comprises a flange portion 156 (best seen in FIG. 11) that supports side walls 120 and 122. Upper portion 154 also provides support for side wall 120 and float switch 134. Cover support 160 has a box structure that is supported by upper portions 154 of side supports 146 and 148.

Cover 118 is situated within cover support 160 and is removable for ease of cleaning and maintenance. Cover 118 comprises a large part 162 and a small part 164 that are joined by a hinge 166. Small part 164 is rotatable through hinge 166 between an open position shown in FIG. 9 and a closed position (not shown) in which it rests in cover support 160. A drain cover 168 is disposed in cover part 166 and is in registry with drain pipe 144 when cover part 166 is in the closed position.

Controller 48 controls the filling of well 114 based on float switches 134. When the water level dips below the lower float switch 134, controller 48 responds by operating the liquid valve to supply water via the liquid inlet 140 to well 114. When the water level reaches the upper float switch 134, controller 48 responds by operating the liquid valve to stop supplying water to well 114. Optionally, well 114 can be filled manually when top cover 118 is opened or removed.

While several embodiments in accordance with our present disclosure have been shown and described, it is to be clearly understood that the same may be susceptible to numerous changes apparent to one skilled in the art. Therefore, the disclosure is not limited to the details shown and described but intend to show all changes and modifications that come within the scope of the appended claims.

What is claimed is:

1. A food holding cabinet comprising:
a plurality of walls that define a food holding chamber; and
an ultrasonic misting device disposed to inject a fine mist into said food holding chamber to provide a humid environment.

2. The food holding chamber of claim 1, wherein said ultrasonic misting device comprises a well that holds a liquid and a plurality of ultrasonic transducers that agitate said liquid to produce said fine mist.

3. The food holding chamber of claim 2, wherein said ultrasonic transducers are disposed in a bottom of said well.

4. The food holding chamber of claim 2, wherein said ultrasonic misting device further comprises first and second float switches disposed in said well and a controller that responds to the operation of said first and second float switches to operate said ultrasonic transducers to agitate or not agitate said liquid.

5. The food holding chamber of claim 1, further comprising a mist dispenser to distribute said fine mist evenly in said food holding chamber.

6. The food holding chamber of claim 5, further comprising a duct that conveys said fine mist from said well to said mist dispenser.

7. The food holding chamber of claim 1, further comprising a plurality of tiers, and wherein said fine mist is injected into a lower one of said tiers.

8. A method of providing humidity to a food holding chamber comprising
operating one or more ultrasonic transducers to agitate a liquid to produce a fine mist; and
injecting said fine mist into said food holding chamber.

9. The method of claim 8, further comprising providing a well to hold said liquid.

10. The method of claim 8, wherein said operating step responds to a level of said liquid in said well to agitate or not agitate said liquid.

11. The method of claim 8, further comprising distributing said fine mist evenly in said food holding chamber.

12. The method of claim 8, wherein said food holding chamber comprises a plurality of tiers, and wherein said fine mist is injected into a lower one of said tiers.
